(19) United States
(12) Patent Application Publication
(10) Pub. No.: US 2010/0065516 A1
(43) Pub. Date: Mar. 18, 2010

(54) MERCHANDISE DISPLAY LOCKING MECHANISM

(76) Inventor: DOV EHRMAN, Brooklyn, NY (US)

Correspondence Address: Pearl Cohen Zedek Latzer, LLP, 1500 Broadway, 12th Floor, New York, NY, 10036, US

(21) Appl. No.: 12/408,602

(22) Filed: Mar. 20, 2009

Related U.S. Application Data
(60) Provisional application No. 61/038,309, filed on Mar. 20, 2008.

(51) Int. Cl. E05B 73/00

(52) U.S. Cl. 211/4

(57) ABSTRACT

A merchandise display case allows a row of packaged products to be displayed for retail sale with a safety bar innocuously placed slightly in front of and slightly above the packaged product, in a position that does not interfere with ordinary movement of the products in and out of the display case row. The bar can be moved downward and secured in a lower position to lock the packaged products in place behind the bar. The bar could engage a hook at the rear side of the item or its packaging. Or a smaller portion of the item can be projected forward toward the front edge of the display shelf and a larger portion of the item can be toward the back end of the display shelf, and the locking bar is situated toward the back end of the item to restrain it from moving forward.

### CROSS REFERENCE TO RELATED APPLICATION

This application claims the benefit under 35 U.S.C. §119(e) of U.S. Provisional Patent Application No. 61/038,309, filed Mar. 20, 2008.

### BACKGROUND OF THE INVENTION

This invention relates generally to the field of systems for use in display of saleable items. More particularly, the present invention pertains to retail merchandise display cases that provide display of saleable items in a theft-resistant manner.

It is desirable in a retail sale environment to allow the potential customer to see and handle, or at least to closely inspect, the product offered for sale. However, watches or other small products that are similarly packaged and are on display for retail sale are particularly susceptible to consumer theft due to their small size and their relatively high value. It has long been a problem in the retail sales field to allow potential customers to closely inspect such retail sale items while simultaneously securing these items to prevent theft by those same potential customers.

Some display systems have small size and high value products that are displayed for retail sale secured within a display case whose front facing either is transparent or has security bars. In such a situation, the potential customer can see but not touch the item. Should the potential customer desire a closer inspection of the item, a salesperson must physically open the display case and remove the item. Often the retail establishment will require that the salesperson be physically present while the customer inspects the item.

Such display systems, however, do not offer potential customers a friendly retail sales environment. When such display systems are used, the express message being given to the customers is that they are not being trusted to handle the merchandise due to fear of theft.

In addition, such display systems do not offer the retail establishment the option to decide whether or not to keep products secured, without having to provide major modifications. It would be desirable for the retail establishment to be able to decide at various times and without warning to display certain or all items within the display system unsecured and to be able to make such a modification without significant effort.

### SUMMARY OF THE INVENTION

It is one object of the present invention to provide a retail establishment, e.g., a pharmacy, with a merchandise display system having an option to lock certain retail products, such as the higher end products, within it.

It is another object of the present invention to provide a “touch and feel” shopping experience to customers or potential customers, either with or without intentions to buy the displayed product, likely would want to analyze the product more vividly by touching and feeling the materials and quality.

It is a further object of the present invention to provide the retailer with the ability to decide, for each product display, which products would be locked and when, without having to make significant modifications to the display case.

In accordance with these and other objects of the invention, the invention provides a merchandise display case that allows a row of packaged products to be displayed for retail sale. The display case has a safety bar that is innocuously placed slightly in front of and slightly above the packaged product. In this position, the bar does not interfere with the ordinary movement of the packaged products in and out of the display case row. When desired, however, the retailer can have the bar moved downward and secured in a lower position. In this position, the bar prevents the ordinary movement of the packaged products in and out of the display case row, such that the packaged products are locked in place behind the bar.

In one embodiment, the bar could be lowered such that it engaged a hook that is provided at the rear side of the saleable item or its packaging to prevent the item from being removed from the shelf.

In another embodiment, a smaller portion of the saleable item is projected forward toward the front edge of the display shelf and toward the consumer, and a larger portion of the saleable item remains toward the back end of the display shelf and away from the consumer. The locking bar is situated toward the back end of the item to restrain it from moving forward.

In one embodiment, the merchandise display case allows several rows of packaged products to be displayed on above another. In such an embodiment, the retailer can have the bar moved downward and secured in a lower position, either for all rows at the same time or for each row individually.

This locking mechanism acts as a standard locking mechanism to stop the theft of “high pilferage” items. However, while stopping theft, the locking mechanism still gives the item being sold an open air feel, which allows the customer to grasp the item, making it more likely for the customer to purchase the item on impulse.

Furthermore, because this locking mechanism gives the product an open air feel, the customers will spend more time looking and feeling the product, giving employees of the establishment more time to help initiate sales. In retail establishments such as pharmacies, where customers do not typically shop for expensive items such as watches or jewelry but where customers often purchase items on an impulse, this locking mechanism would be particularly beneficial for increasing sales. In one such situation, a customer filling a prescription or buying over the counter drugs, might glance at the watches, become impressed, reach out and feel the product's packaging and, on an impulse, buy it.

The present invention will be better understood by reference to the following detailed discussion of specific embodiments and the attached figures, which illustrate and exemplify such embodiments.

### BRIEF DESCRIPTION OF THE DRAWINGS

Embodiments of the invention will be understood and appreciated more fully from the following detailed description in conjunction with the figures, which are not to scale, in which like reference numerals indicate corresponding, analogous or similar elements, and in which:

FIG. 1 shows a schematic drawing of a multi-row retail merchandise display case of the present invention;

FIG. 2 shows a schematic drawing of a row of the multi-row retail merchandise display case of FIG. 1 with the locking mechanism in an open position;

FIG. 3 shows a schematic drawing of a cross-sectional side view of the internal mechanism of the row of FIG. 2 taken along line G-G thereof;

FIG. 4 shows a schematic drawing of a row of the multi-row retail merchandise display case of FIG. 1 with the locking mechanism in a closed position;

FIG. 5 shows a schematic drawing of a cross-sectional side view of the internal mechanism of the row of FIG. 4 taken along line K-K thereof;

FIG. 6 shows a photograph of an actual multi-row retail merchandise display case of the present invention;

FIG. 7 shows a photograph of one row of the multi-row retail merchandise display case of FIG. 6 with the locking mechanism in an open position; and

FIG. 8 shows a photograph of one row of the multi-row retail merchandise display case of FIG. 1 with the locking mechanism in a closed position.

### DETAILED DESCRIPTION OF THE INVENTION

The following preferred embodiments as exemplified by the drawings are illustrative of the invention and are not intended to limit the invention as encompassed by the claims of this application.

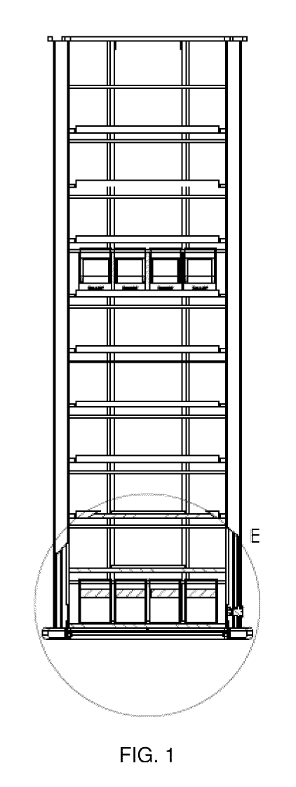

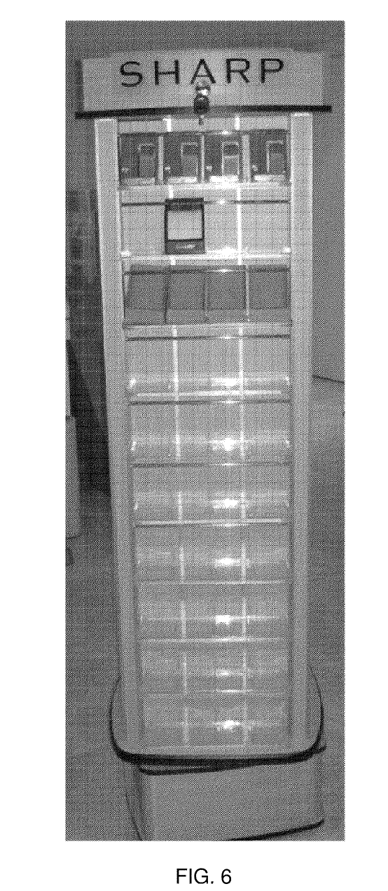

In a first embodiment of the retail merchandise display locking system, the display system, or case, may be in the form of a countertop display having one row of merchandise. More typically, however, such a display case might have a large tower with multiple display rows, as depicted in FIG. 1 and as photographed in FIG. 6. The multi-row display tower could house many different types of items, including, for example, brand name watches.

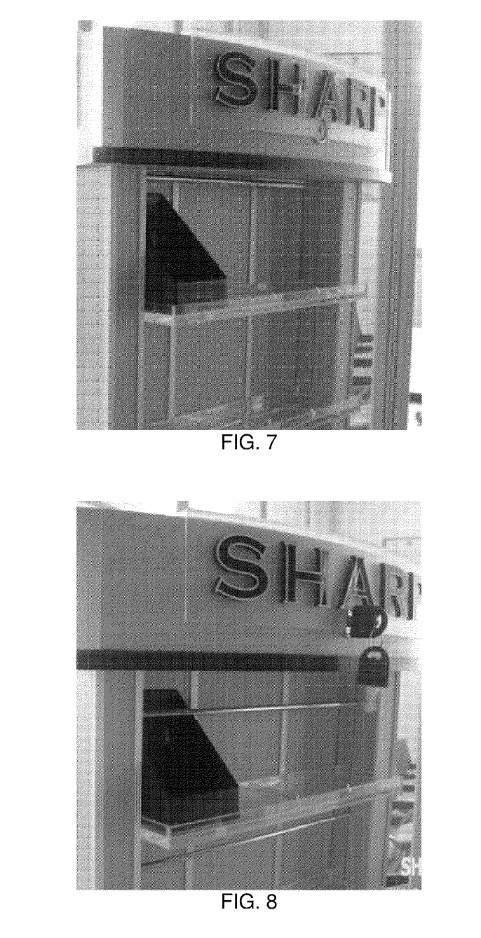

The display case of the present invention makes use of a locking bar 20 that is innocuously placed across the display shelf and through the volume of the display space. Bar 20 is situated slightly in front of and slightly above the packaged product, as can best be seen in FIG. 7. In this position, the bar does not interfere with the ordinary movement of the packaged products in and out of the display case row.

When desired, the retailer can move the bar downward to secure it in a lower position. In this lower position, as can best be seen in FIG. 8, the bar prevents the ordinary movement of the packaged products in and out of the display case row, such that the packaged products are locked in place behind the bar.

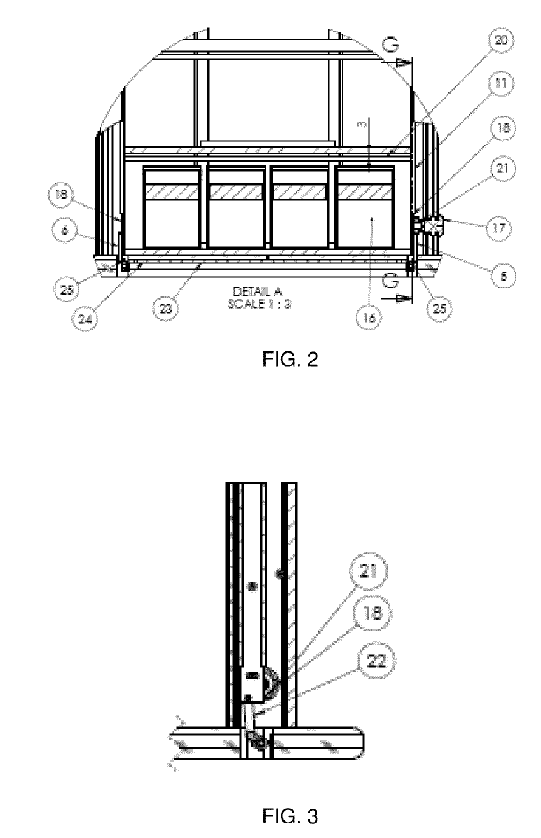

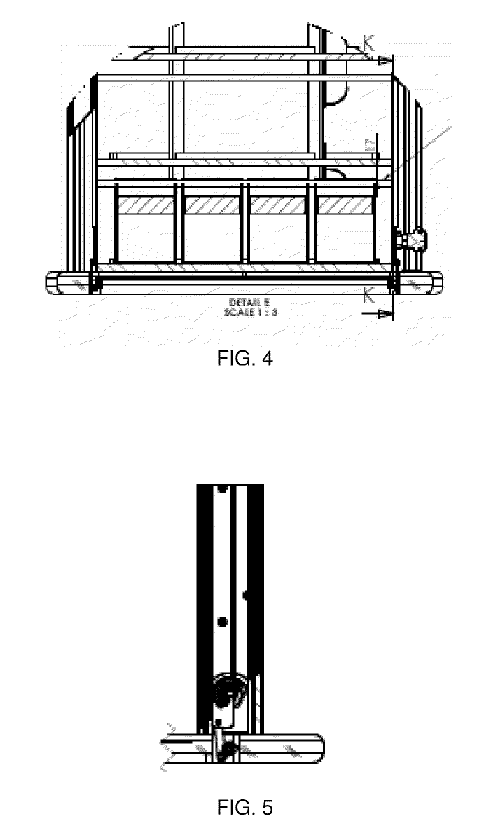

The locking bar 20 may be moved downward in various ways. In a first embodiment, as shown in FIGS. 2 and 3, an actuator 17 may be used to move bar 20 up or down, locking it into a specifically designed curved area built into the box 16, which is the retail item's display space. Bar 20 may be connected on either side of the mechanism to a sliding metal strip 18. An adaptor 21 links the lock 17 to a sliding metal strip 18. When the actuator 17 is turned or actuated, an adaptor 21 causes the sliding metal strip 18 to move downwards and this in turn causes the bar 20 to move downwards and engage or lock the item into the display space.

In one embodiment, the rear side of the saleable item or its package has a hook that is engaged by the bar 20. In this embodiment, bar 20 is lowered into a hook provided at the rear side of the saleable item or its package and engages the hook, which prevents the item from being removed from the shelf while bar 20 is in its lowered position and engaged with the hook. The hook can be an external hook that is added onto the item packaging or could be in the foam of a section of the packaging that has been molded to form a hook.

In this embodiment, the path of the bar as it is lowered into its locked position, when viewed sideways, is most likely curved in some fashion from its raised, unlocked position to a lowered position where it is engaged by the hook. Alternatively, the path of the bar as it is lowered into its locked position can be straight downward from its raised, unlocked position, and in such a case the bar might not be engaged by the hook until and unless a potential customer attempts to remove the product package from the shelf, whereupon the movement of the item package outward fro the shelf causes the hook to engage the bar.

In another embodiment, the saleable item or its package has a smaller portion that is positioned forward toward the front edge of the display device row and toward the consumer, and also has a larger portion that is positioned toward the back end of the display device row and away from the consumer. In this embodiment, bar 20 is lowered and is situated in front of the larger portion of the item, which prevents the item from being removed from the shelf while bar 20 is in its lowered position and blocking the item.

In this embodiment, the path of the bar as it is lowered into its locked position, when viewed sideways, can be straight downward from its raised, unlocked position.

If the actuator has a key (see right side of FIG. 2) and one side is locked tightly, the opposite side needs to be secured as well—this is accomplished through the small arm 5 that is connected to the sliding metal strip 18, which in turn activates the rod 23. This rod 23 is connected on its opposite end to another arm 6, which lifts and lowers the sliding metal rod on that opposite (left) side of the mechanism. This function causes both sliding strips to move simultaneously, lowering the rod 23 into its locked position, which is now securely locked on both sides of the shelf. To unlock, the actuator key is turned in the opposite direction, reversing the above process and unlocking the boxes from the shelf. This allows access by store personnel in order to either show the product to the customer, or finalize the sale of the item.

The locking system may be activated by an actuator 17, such as a key that turns a keyhole. Such a key may be, for example, on the front or side of the display case, but should be presented where it may control the locking bar for one or more display items spaces or rows. There is also the option of employing a combination lock in place of the key-locking mechanism.

Alternatively, the actuator can offer two options to unlock, keys or combination lock. Thus, if the keys for the actuator lock are lost, the lock will revert to the combination. Similarly, if the combination number is unavailable, the key will unlock the actuator. This will make selling easier to the employees and will make buying more pleasant for the customers, which will automatically increase sales. Thus, displays could be set to be secured in any of the two positions, locked or unlocked, meaning stores will have independence to keep locked or unlocked at any given time or period without significant effort.

FIGS. 6-8 show the actuator in the top center of a multi-row display case. In this embodiment, the actuator controls the locking bar for the entire display case. Alternatively, each actuator may control the locking bar only one row on an entire display case or more than one row in a display case. In this embodiment, the actuator could be situated on the front or on the side of the display case, adjacent to the row or rows that are being controlled thereby.

Thus, a merchandise display locking system has been provided. One skilled in the art will appreciate that the present invention can be practiced by other than the described embodiments, which are presented for purposes of illustration and not limitation, and that the invention is limited only by the claims that follow. Further, since numerous modifications and changes will readily occur to those skilled in the art, it is not desired to limit the invention to the exact construction and operation shown and described, and accordingly, all suitable modifications and equivalents may be resorted to, without departing from the scope or spirit of the invention as defined in the appended claims.

1. A merchandise display locking system comprising:
a housing having at least one row having a display space therein, said display space having at least one packaged saleable item situated thereon, wherein each row comprises a bar extending thereacross and through the display space,
said bar being situated so as to engage packaging of said saleable item and prevent outward movement of said saleable item.
